(19) United States
(12) Patent Application Publication
(10) Pub. No.: US 2023/0342697 A1
(43) Pub. Date: Oct. 26, 2023

(54) WORK SUPPORTING APPARATUS AND WORK SUPPORTING SYSTEM

(71) Applicant: Hitachi, Ltd., Tokyo (JP)

(72) Inventors: Shingo HAYASHI, Tokyo (JP); Shoji YAMAMOTO, Tokyo (JP); Takaaki UENO, Tokyo (JP); Masahiko NIIOKA, Tokyo (JP)

(21) Appl. No.: 18/115,860

(22) Filed: Mar. 1, 2023

(30) Foreign Application Priority Data
Apr. 21, 2022 (JP) 2022-070393

(51) Int. Cl. G06Q 10/0639; G06F 11/30

(52) U.S. Cl. CPC G06Q 10/0639; G06F 11/3086

(57) ABSTRACT

A work supporting apparatus according to the present invention acquires, from a work terminal, an update date and time of a data file on the work terminal and a position on the data file currently displayed by the work terminal, and specifies an updated portion of the data file updated on the work terminal, based on the acquired update date and time and the acquired position on the data file.

### CROSS-REFERENCE TO RELATED APPLICATION

This application claims the priority of Japanese Patent Application No. 2022-070393 filed on Apr. 21, 2022, which is incorporated herein by reference in its entirety.

### BACKGROUND OF THE INVENTION

### 1. Field of the Invention

The present invention relates to a technology for supporting work performed by a worker at a work site.

### 2. Description of the Related Art

Due to rapid changes in the social environment and diversification of customer needs, digitization has become an issue in all areas of corporate activities. However, the competition for human resources acquisition is intensifying beyond the boundaries of industry types and business modes in order to solve the chronic labor shortage associated with population declines and population aging. Under such circumstances, it is necessary to improve the productivity of people and facilities in order to obtain maximum benefits with limited human resources, while maintaining global competitive superiority.

Here, management operations at a manufacturing site will be considered. In management operations at a manufacturing site, the progress status of a manufacturing process is managed in order to realize smooth production. If the progress status can be managed properly, even if a work delay occurs, it is possible to deal appropriately with a change in personnel allocation, overtime work, and the like, according to the situation. However, in a manufacturing site with a paper-based operation, the lead time from work to reporting is long, and it is difficult to grasp an accurate progress status in real time.

In response to such a situation, a work supporting system utilizing a wearable terminal of electronic paper or the like has attracted attention in the manufacturing industry. For example, in a case where electronic paper is applied to an inspection operation, a work result can be recorded as time-series electronic data. Because work information indicating who performed the work and how the work is performed is recorded in the time-series data, the progress status can be visualized using data analysis. Furthermore, electronic data analysis processing is more accurate and faster than paper-based manual work, and a data file in which the information is recorded can be shared via a network. By utilizing a wearable terminal in this manner, productivity at a manufacturing site can be improved.

In a case where a wearable terminal of electronic paper or the like is applied to a work supporting system, a thin and lightweight wearable terminal is desirable in order to reduce the burden on the worker. For this reason, the function of the wearable terminal is specialized for reading and writing, and processing involving a load is generally performed on another computer via a network. However, in a case where a data file in a terminal is shared, the time taken to collect the file and the time required to analyze the collected file become longer as the file capacity or the number of terminals increases, and thus, there arises a new problem that the real-time properties of the analysis result (progress status) are impaired.

In JP 2015-130148 A, in order to solve the problem of “efficiently updating information managed by an operation support system.”, an “operation supporting apparatus 10a includes: a storage unit that stores support data for supporting operations that includes common document information and individual document information; an update unit that updates the support data; and a processing unit that creates change data to mirror the updated support data in data stored by another apparatus. The update unit stores, in separate data units or directory units, common document change information indicating the updated portion of the common document information of the support data, individual document change information indicating the updated portion of the individual document information of the support data, and a change file directory in which the file after the change to the individual document information is stored, and the processing unit extracts the change data from the separate data or directory.” (see Abstract).

### SUMMARY OF THE INVENTION

JP 2015-130148 A discloses a technique for registering update information in a database via another apparatus when a file update in the apparatus is detected. A case where the technique is applied to a work supporting system will be considered. In this case, when a wearable terminal detects a file update, the update information can be registered in a database via another computer. As a result, the work information in the wearable terminal can be efficiently registered in the database. However, intermittently performing processing involving a load in the wearable terminal causes an operational delay of the terminal. In addition, there is a problem that the real-time properties of the analysis result (progress status) described above are impaired.

The present invention was conceived in view of the above problems, and an object of the present invention is to provide a technique that enables a data file on a work terminal to be collected quickly and efficiently when the data file is updated.

A work supporting apparatus according to the present invention acquires, from a work terminal, an update date and time of a data file on the work terminal and a position on the data file currently displayed by the work terminal, and specifies an updated portion of the data file updated on the work terminal, based on the acquired update date and time and the acquired position on the data file.

### Advantageous Effects of Invention

With the work supporting apparatus of the present invention, when a data file on a work terminal is updated, the data file can be collected quickly and efficiently. Problems, configurations, advantageous effects, and the like other than those described above will be clarified by the following description of embodiments.

### BRIEF DESCRIPTION OF THE DRAWINGS

FIG. 1 is a diagram illustrating methods of collecting data files held by a work terminal;

FIG. 2A is a sequence chart illustrating a general procedure in which a server 102 analyzes a data file on a work terminal 105;

FIG. 2B is a sequence chart illustrating a procedure for acquiring, from the work terminal 105, update information indicating whether a data file has been updated on the work terminal 105;

FIG. 3 shows a configuration, and a data example of, update history data 300 accumulated by the server 102;

FIG. 4 is a configuration diagram of a server 102;

FIG. 5 is a flowchart illustrating an operating procedure of the server 102;

FIG. 6 is a diagram showing, by way of example, types of data files used on the work terminal 105;

FIG. 7 is a flowchart illustrating an operating procedure in a case where a data acquisition unit 1022 switches which data is to be acquired according to the format of the data file;

FIG. 8 is a schematic diagram illustrating a range of work terminals 105 monitored by a server 102 according to a second embodiment;

FIG. 9 is a flowchart illustrating a procedure when the monitoring unit 1021 performs the operation of FIG. 8;

FIG. 10 is a schematic diagram illustrating another configuration example of the range of work terminals 105 monitored by the server 102;

FIG. 11 is a flowchart illustrating a procedure when the monitoring unit 1021 performs the operation of FIG. 10;

FIG. 12 is a schematic diagram illustrating a range of data files collected by a server 102 according to a third embodiment;

FIG. 13 is a flowchart illustrating a procedure when the data acquisition unit 1022 performs the operation of FIG. 12;

FIG. 14 is a schematic diagram illustrating a range of work terminals 105 collected by the server 102 according to the third embodiment;

FIG. 15 is a flowchart illustrating a procedure when the data acquisition unit 1022 performs the operation of FIG. 13:

FIG. 16 is a schematic diagram illustrating a range of work terminals 105 collected by the server 102 according to the third embodiment;

FIG. 17 is a flowchart illustrating a procedure when the data acquisition unit 1022 performs the operation of FIG. 16;

FIG. 18 is a schematic diagram illustrating a range of work terminals 105 collected by the server 102 according to the third embodiment;

FIG. 19A is a flowchart illustrating a procedure when the data acquisition unit 1022 performs the operation of FIG. 18; and

FIG. 19B is a flowchart illustrating another procedure when the data acquisition unit 1022 performs the operation of FIG. 18.

### DESCRIPTION OF THE PREFERRED EMBODIMENTS

### First Embodiment

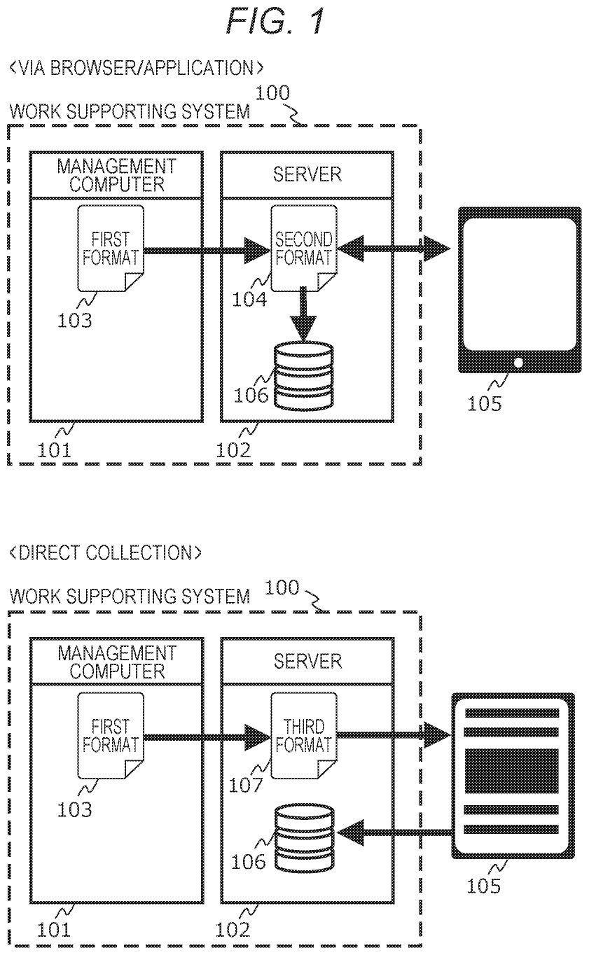

FIG. 1 is a diagram illustrating a method of collecting data files held by a work terminal. A work supporting system 100 is configured from a management computer 101, a server 102, and a work terminal 105, and supports work performed by a worker on the work terminal 105. Methods of collecting data held by the work terminal 105, include, for example, the methods illustrated in the upper section and the lower section of FIG. 1.

The method in the upper section of FIG. 1 will now be described. The worker inputs work content on the work terminal 105 via a web browser, and the server 102 records the work content on a data file 104 in a second data format (for example, HTML format). In a case where a manager provides information to the work terminal 105, the management computer 101 provides a data file 103 in a first data format to the server 102, and the server 102 converts the data file into the second data format. The work terminal 105 is capable of browsing the information on a web browser. In a case where data is aggregated, the server 102 stores the data file 104 in a database 106. In this method, a data file 104 in which work content is recorded is created on the server 102 from the outset.

The method in the lower section of FIG. 1 will now be described. The management computer 101 provides the data file 103 in the first data format to the server 102, and the server 102 converts the data file into the data file 103 in a third data format (for example, PDF format). The work terminal 105 acquires a data file 107, and the worker records the work content in the data file 107 via the work terminal 105. When the data is aggregated, the server 102 re-acquires the data file 107 from the work terminal 105 and stores the data file in the database 106. This method is different from the upper section of FIG. 1 in that a data file for recording the work content is held on the work terminal 105.

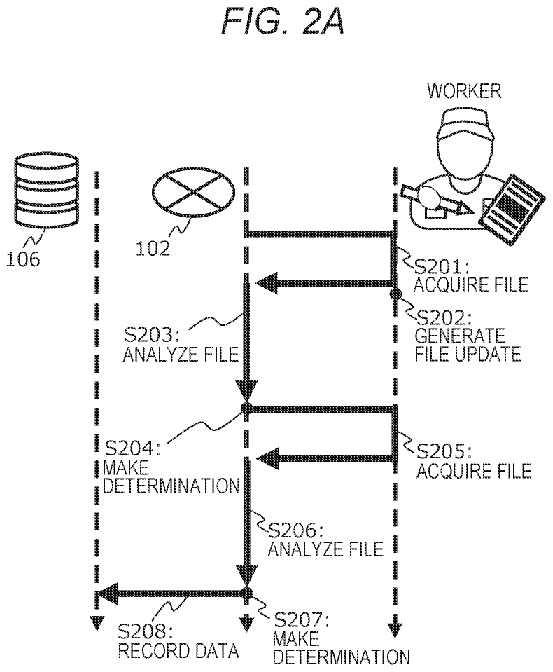

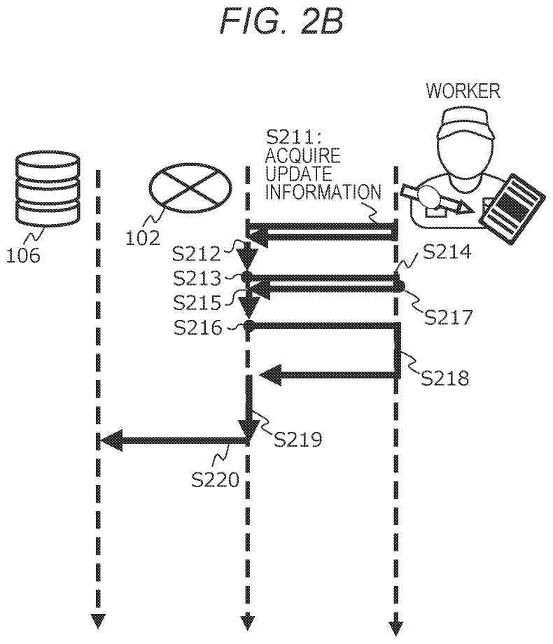

FIG. 2A is a sequence chart illustrating a general procedure in which the server 102 analyzes a data file on the work terminal 105. Here, it is assumed that the work terminal 105 holds the data file as illustrated in the lower section of FIG. 1. When the data file on the work terminal 105 is updated, the server 102 stores the updated content in the database 106. Therefore, the analysis procedure is as follows.

In S201, the server 102 acquires a data file from the work terminal 105, and analyzes the file content in S203. It is assumed that a data file is updated on the work terminal 105 between S201 and S203 (S202). In S204, the server 102 determines whether the data file has been updated. Because the data file has been updated in S202, it is determined that the data file has been updated. In S205, the server 102 re-acquires the data file from the work terminal 105, and analyzes the data file in S206. In S207, the server 102 extracts the updated content, and in S208, records the updated content in the database 106.

In such a general data collection procedure, in order to determine whether a data file has been updated on the work terminal 105, the server 102 needs to repeatedly acquire the data file from the work terminal 105. As a result, the work terminal 105 and the server 102 are both subjected to a processing load for each instance of collection processing.

FIG. 2B is a sequence chart illustrating a procedure for acquiring, from the work terminal 105, update information indicating whether a data file has been updated on the work terminal 105. It is assumed that the work terminal 105 holds a data file as illustrated in the lower section of FIG. 1. In this sequence chart, unlike FIG. 2A, the server 102 acquires the data file from the work terminal 105 and analyzes the updated content only in a case where the update information indicates that the data file has been updated on the work terminal 105. Otherwise, the server 102 acquires only the update information from the work terminal 105, and does not acquire the data file body. In the present invention, by using this sequence chart, it is possible to suppress the load associated with acquisition of a data file.

In S211, the server 102 acquires the update information from the work terminal 105. The update information is information indicating whether or not the data file on the work terminal 105 has been updated, and has a smaller data size than the data file body. A specific example of the update information will be described below. The server 102 analyzes the update information (S212), and determines that the data file has not been updated (S213). The server 102 repeats the processing to acquire the update information, for example, at predetermined intervals (S214). It is assumed that the worker updates the data file on the work terminal between S214 and S215 (S217). The server 102 analyzes the update information (S215) and determines that the data file has been updated (S216). The server 102 acquires the updated portion of the data file from the work terminal 105 (S218). The server 102 analyzes the acquired updated portion to specify the work content (S219), and records the work content in the database 106 (S220).

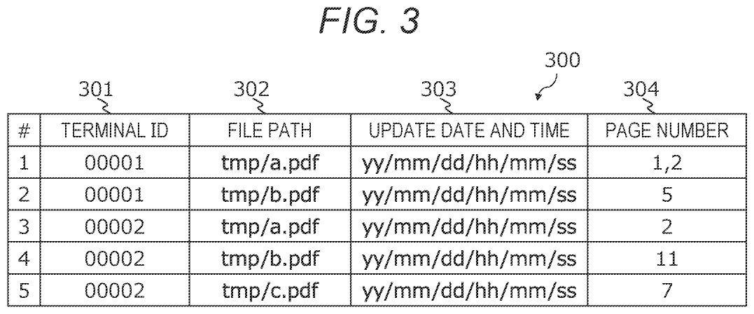

FIG. 3 shows a configuration and a data example of update history data 300 accumulated by the server 102. Based on the update information acquired from the work terminal 105, the server 102 specifies the portion for which the data file has been updated (the number of the updated page) on the work terminal 105, and accumulates, as an update history, the portion together with the update date and time. The update history data 300 includes a terminal ID 301, a file path 302, an update date and time 303, and a page number 304. The update history data 300 can be stored in the database 106.

The updated portion of the data file can be specified as follows. The work terminal 105 is configured to receive, from an external terminal, a command designating a data file to query the update date and time of the data file, and respond with the update date and time in response to the command. The work terminal 105 is further configured to receive, from the external terminal, a command querying the data file currently displayed by the work terminal 105 and the page number currently displayed, and to respond regarding the data file and the page number in response to the command. The server 102 transmits these two commands (which may be formally aggregated as one command) to the work terminal 105 every several hundred milliseconds, for example, and receives a response thereto, and hence it is possible to monitor the updated data file and the updated page number thereof on the work terminal 105.

For example, it is assumed that, for the terminal ID “0001”, the update date and time of a data file “tmp/a.pdf” advances from the previous acquisition time, and that the page number displayed by the work terminal 105 at that time is “2”. In this case, the server 102 is capable of specifying that the page number “2” has been newly updated. Every time a newly updated page number is specified, the server 102 adds the page number to the page number 304 and overwrites and updates the update date and time 303. The server 102 accumulates the update history data 300 by performing similar processing for each terminal ID 301 and file path 302.

The update history data 300 can be created by acquiring the update date and time, the data file currently being displayed, and the page number. Therefore, because it is not necessary to acquire the data file body and analyze the updated content, it is possible to specify the updated content with a smaller processing load and communication amount in comparison with the conventional procedure illustrated in FIG. 2A. The processing load and the communication amount are suppressed for both the server 102 and the work terminal 105.

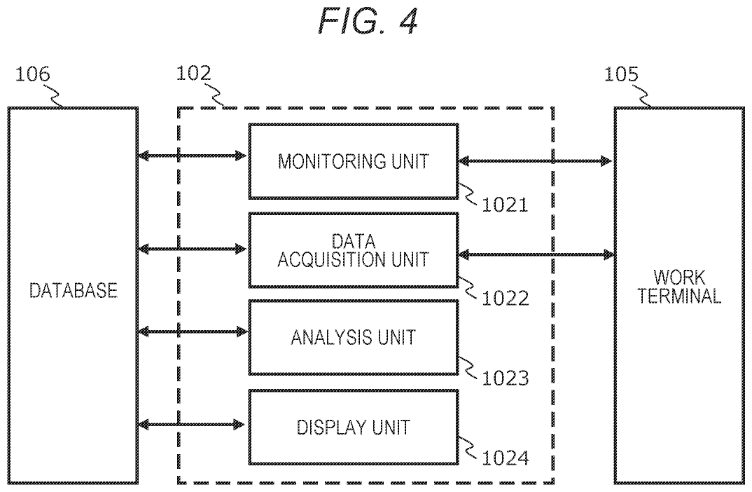

FIG. 4 is a configuration diagram of the server 102. The server 102 (work supporting apparatus) includes a monitoring unit 1021, a data acquisition unit 1022, an analysis unit 1023, a display unit 1024, and a database 106. The monitoring unit 1021 transmits the query command illustrated in FIG. 3 to the work terminal 105 to acquire the update state of the data file, and creates the update history data 300 based on the update state. The data acquisition unit 1022 acquires an updated portion of the data file on the work terminal 105. The updated portion is specified by the monitoring unit 1021 in the process in which the monitoring unit 1021 creates the update history data 300. The analysis unit 1023 analyzes the updated portion to specify the work content performed on the work terminal 105, and records the work content in the database 106. The display unit 1024 displays information stored in the database 106. The database 106 can be configured by storing a data file in a storage unit.

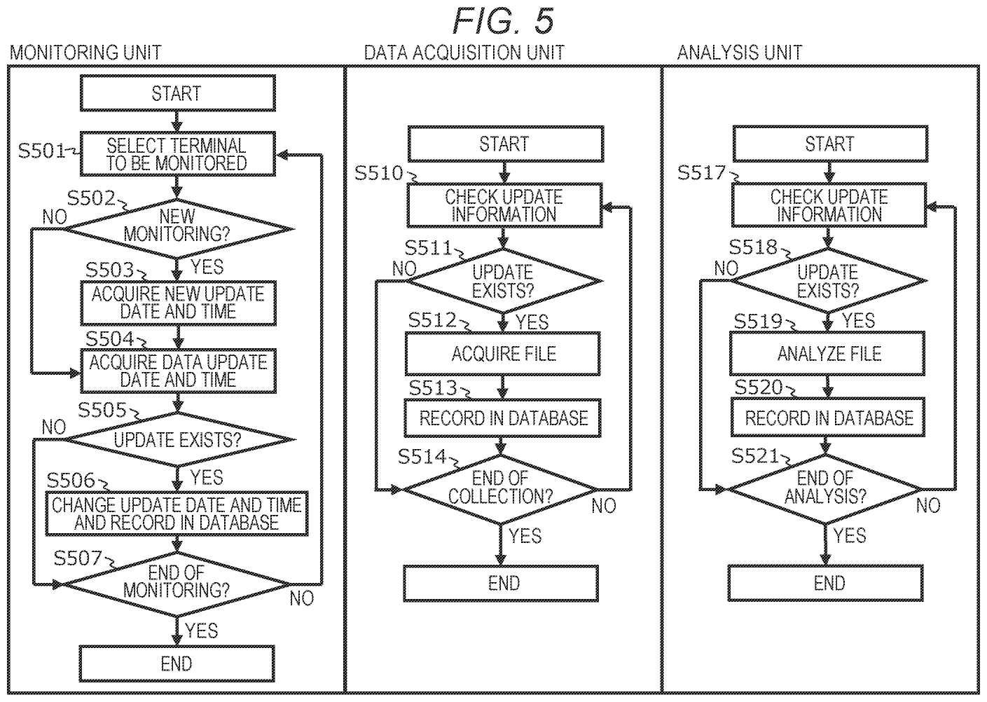

FIG. 5 is a flowchart illustrating an operating procedure of the server 102. The monitoring unit 1021, the data acquisition unit 1022, and the analysis unit 1023 are capable of operating independently of, and in parallel with, one another. Each step of FIG. 5 will be described below.

The monitoring unit 1021 selects the work terminal 105 for which updated content is to be monitored (S501). If the update date and time 303 has just been updated, the monitoring unit 1021 acquires the latest value of the update date and time 303 again (S503), and transmits a query command to the work terminal 105 to acquire the update date and time of the data file (S504). In a case where the data file is updated (S505: YES), the update date and time 303 is overwritten with the update date and time of the data file, and in a case where a new page is updated, the page number is added to page number 304 (S506). The monitoring unit 1021 repeats the above processing until the monitoring is terminated (S507).

The data acquisition unit 1022 queries the update history data 300 (S510) to check whether there is a page number of a newly updated data file (S511). In a case where there is an updated page (S511: YES), the data acquisition unit 1022 acquires only the newly updated page in the data file (S512), and stores the page in the database 106 (S513). The data acquisition unit 1022 repeats the above processing until the data collection is terminated (S514). Because the data acquisition unit 1022 acquires only the updated page in the data file from the work terminal 105, the load of the collection processing can be suppressed.

The analysis unit 1023 queries the update history data 300 (S517) to check whether there is a page number of a newly updated data file (S518). In a case where there is an updated page (S518: YES), the analysis unit analyzes only the newly updated page in the data file (S519), and stores the analysis result in the database 106 (S520). The analysis unit 1023 repeats the above processing until the analysis is terminated (S521). Because the analysis unit 1023 analyzes only the updated page in the data file, the load of the analysis processing can be suppressed.

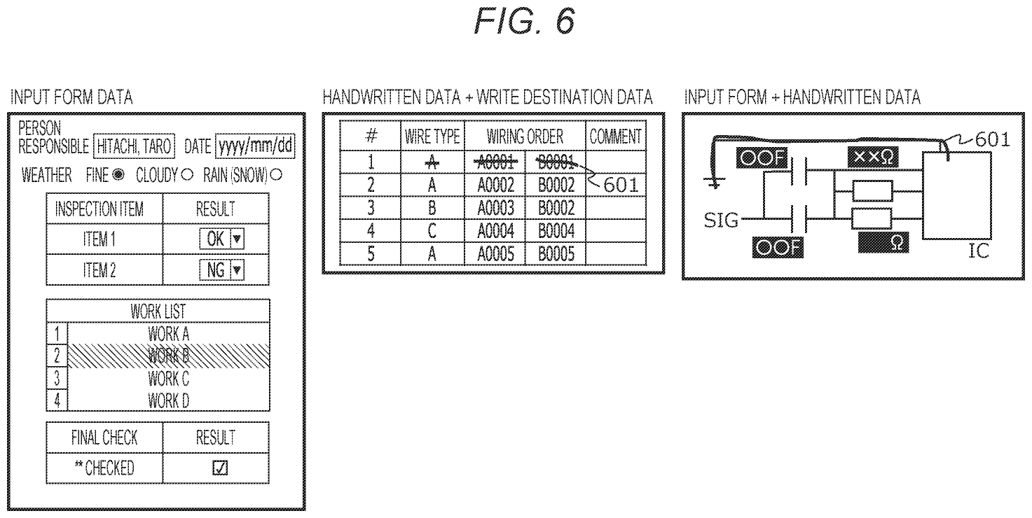

FIG. 6 is a diagram showing, by way of example, types of data files used on the work terminal 105. The input form data is configured from prescribed input screen components (examples: text box, radio button, combo box, list box, check box), and the worker inputs work content to the screen component. The input form data is, for example, a PDF form. The worker may record the work content using a handwritten input 601. In this case, the data in which the handwritten input content is recorded is created in LAF (Lingoes Appendix File) format, for example. The handwritten data can be created separately from the write destination data. Further, in some cases, the handwritten data is written to the input form.

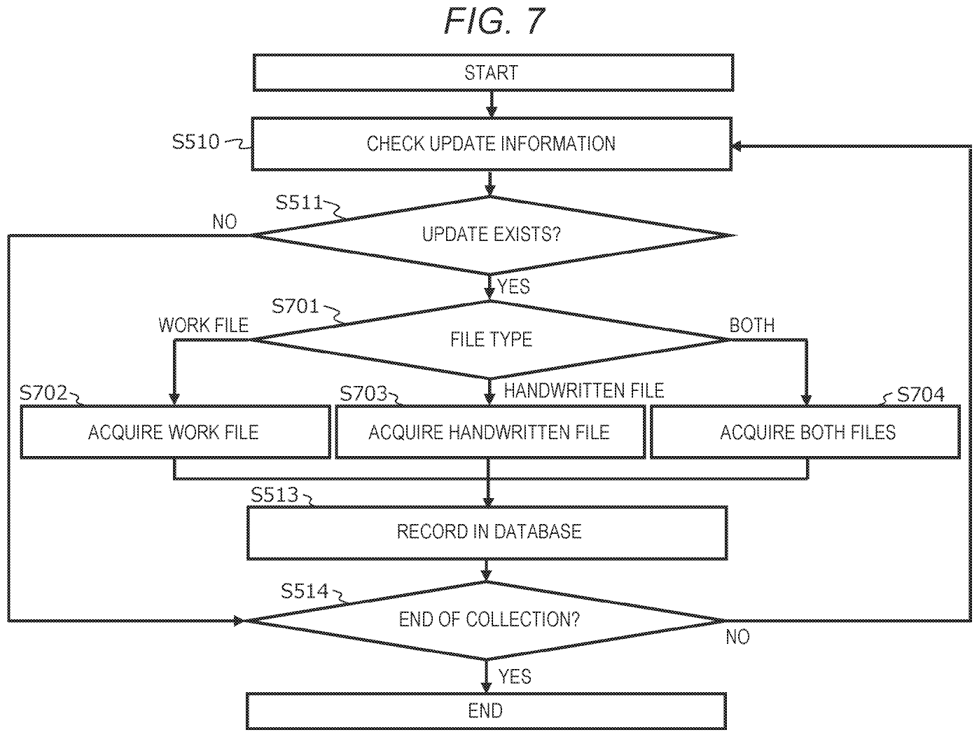

FIG. 7 is a flowchart illustrating an operating procedure in a case where a data acquisition unit 1022 switches which data is to be acquired according to the format of the data file. In this flowchart, S701 to S704 are performed instead of S512 illustrated in FIG. 5. The data acquisition unit 1022 determines the type of data file to be acquired (S701). In a case where the data file is a work file for recording work content in the data file itself such as an input form, the data acquisition unit 1022 acquires the work file (S702). In a case where the data file is configured from the handwritten data and the write destination data, because the write destination data is usually provided to the work terminal 105 by the server 102, the data acquisition unit 1022 only needs to acquire the handwritten data from the work terminal 105 (S703). When the work content is to be recorded in the data file itself and a handwritten input is also to be made, it is necessary to acquire both the data file and the handwritten data (S704).

### First Embodiment: Summary

The work supporting apparatus (server 102) according to the first embodiment acquires the update date and time of the data file on the work terminal 105 and the page number of the data file currently displayed by the work terminal 105, thereby specifying an updated portion of the data file. As a result, the updated portion can be specified without acquiring the entire data file from the work terminal 105 and analyzing the data file. That is, it is possible to suppress the processing load and the communication load for specifying the updated portion.

### Second Embodiment

In a second embodiment of the present invention, a configuration example will be described in which the server 102 suppresses the processing load on the server 102 by narrowing down the work terminal 105 monitoring the update date and time or the data file and the like. Other configurations are similar to those of the first embodiment.

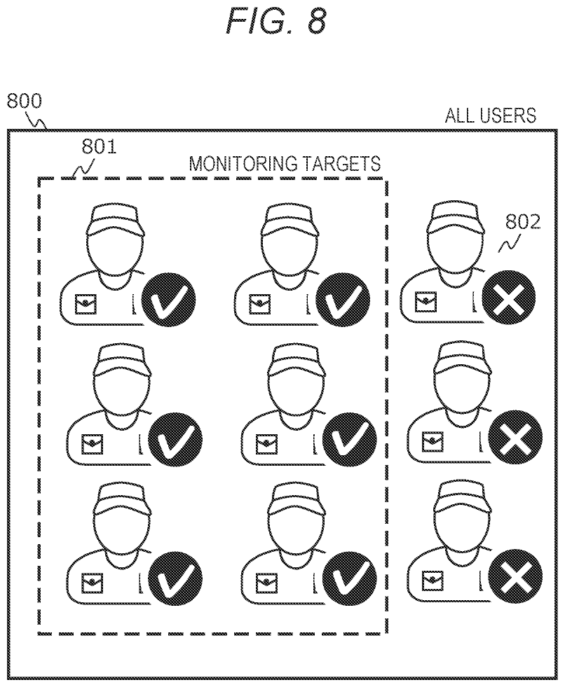

FIG. 8 is a schematic diagram illustrating a range of work terminals 105 monitored by the server 102 according to the second embodiment. The work terminal 105 and an authentication system may be configured such that, when using the work terminal 105, the worker receives a login authentication from the authentication system and is able to use the work terminal 105 only in a case where the worker has been authenticated. In this case, only a user who has received a login authentication from the authentication system and the work terminal 105 used by the user update the data file on the work terminal 105. Therefore, in the second embodiment, the monitoring unit 1021 monitors only a user 801 who has received a login authentication from the authentication system and the work terminal 105 used by the user 801 among all the users 800 who use the work terminal 105, and does not monitor a user 802 who has not received the login authentication or the work terminal 105 used by the user 802. As a result, the processing load of the server 102 can be suppressed.

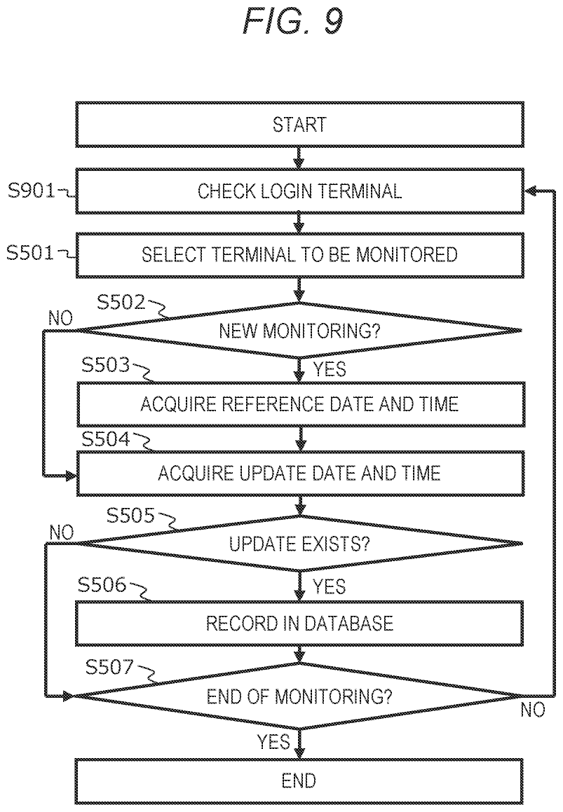

FIG. 9 is a flowchart illustrating a procedure when the monitoring unit 1021 performs the operation of FIG. 8. In addition to the procedure illustrated in FIG. 5, the monitoring unit 1021 performs S901 before S501. In S901, the monitoring unit 1021 specifies the work terminal 105 for which the user has received a login authentication. In S501, the monitoring unit 1021 selects, as the monitoring target, only the work terminal 105 specified in S901.

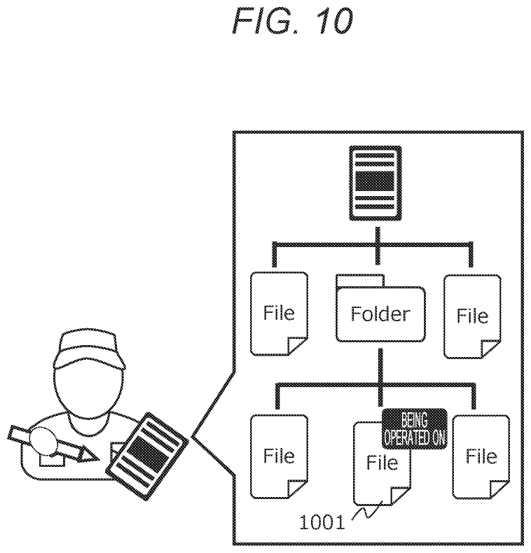

FIG. 10 is a schematic diagram illustrating another configuration example of a range of work terminals 105 monitored by the server 102. A data file which is updated on the work terminal 105 is the data file being operated on by the user on the work terminal 105, and the other data files are not considered to have been updated. Therefore, the monitoring unit 1021 monitors only a data file 1001 being operated on by the user. As a result, the processing load of the server 102 can be suppressed. The file being operated on by the user can be specified by transmitting the command illustrated in FIG. 3 from the server 102 to the work terminal 105.

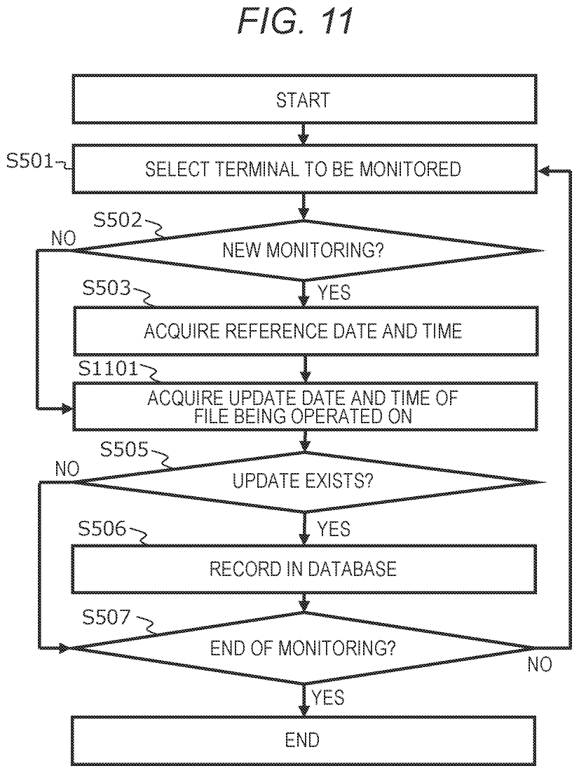

FIG. 11 is a flowchart illustrating a procedure when the monitoring unit 1021 performs the operation of FIG. 10. The monitoring unit 1021 performs S1101 instead of S504 illustrated in FIG. 5. In SI 101, the monitoring unit 1021 acquires the data file being operated on by the user on the work terminal 105, by using the command illustrated in FIG. 3. The monitoring unit 1021 repeatedly transmits a command querying the update date and time and the page number being displayed to the work terminal 105 only for the data file being operated on. Otherwise, the configuration is the same as that of FIG. 6.

### Second Embodiment: Summary

The work supporting apparatus (server 102) according to the second embodiment narrows down the work terminal 105 or the data file for which the monitoring unit 1021 is monitoring the update date and time or the like, to only the work terminal 105 or the data file being worked on. As a result, the processing load of the server 102 can be suppressed. Because a command specifying the data file being operated on is the same as the command according to the first embodiment, it is also useful that the processing load can be suppressed by the same mechanism as in the first embodiment.

### Third Embodiment

In the second embodiment of the present invention, a configuration example will be described in which the processing loads on the server 102 and the work terminal 105 are suppressed by narrowing down the data file collected by the server 102 from the work terminal 105. Other configurations are similar to those of the first embodiment.

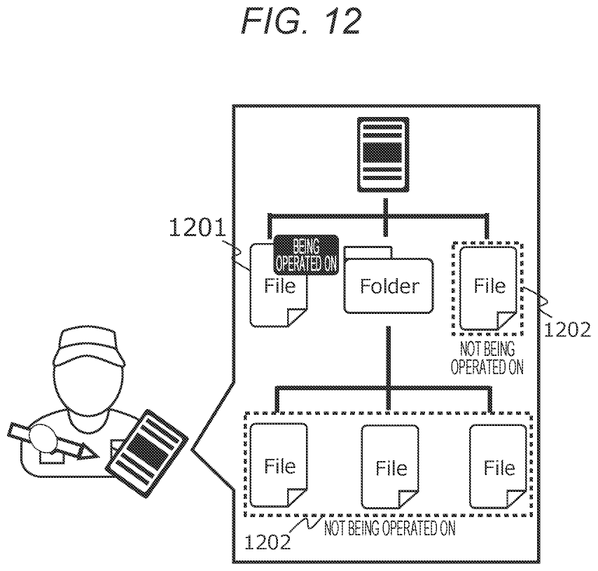

FIG. 12 is a schematic diagram illustrating a range of data files collected by the server 102 according to a third embodiment. Depending on the specification of the work terminal 105, when the data acquisition unit 1022 collects a data file from the work terminal 105, the data file may be configured to be locked on the work terminal 105 (for example, a state in which reference can be made but an update is not possible). As an example, when a data file recorded using the handwritten data and the write destination data illustrated in FIG. 6 is transmitted from the work terminal 105 to the data acquisition unit 1022, the data file may be locked in order to generate a PDF file in which the content of the handwritten data and the write destination data are recorded together. Due to such lock processing, the user is made to interrupt writing to the data file, and there is the possibility of an inconvenience arising such as a decrease in work efficiency.

Therefore, in a third embodiment, the data acquisition unit 1022 does not acquire a data file 1201 which is being operated on by the user on the work terminal 105, and acquires only a data file 1202 which is not being operated on. As a result, even when the data acquisition unit 1022 collects the data file, the user is not made to interrupt the work of writing to the data file being operated on, and hence it is possible to avoid a decrease in work efficiency and so forth.

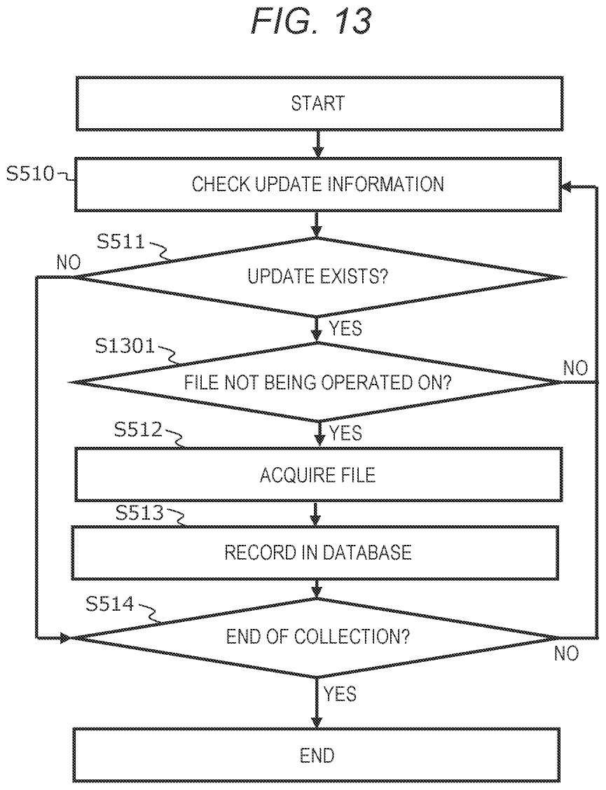

FIG. 13 is a flowchart illustrating a procedure when the data acquisition unit 1022 performs the operation of FIG. 12. The data acquisition unit 1022 performs S1301 between S511 and S512 illustrated in FIG. 5. In S1301, the data acquisition unit 1022 specifies, on the work terminal 105, a data file which is not being operated on by the user. For example, the data acquisition unit 1022 may specify the result of the command illustrated in FIG. 3 by acquiring the result from the monitoring unit 1021. The data acquisition unit 1022 acquires only a data file which is not being operated on, from the work terminal 105. Otherwise, the configuration is the same as that of FIG. 6.

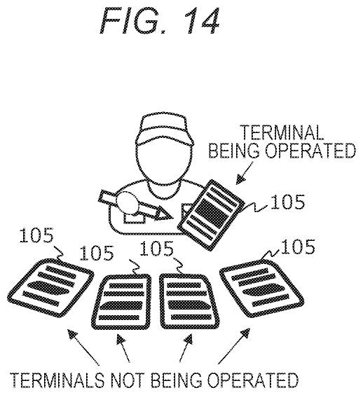

FIG. 14 is a schematic diagram illustrating a range of work terminals 105 collected by the server 102 according to the third embodiment. For example, a user may simultaneously use a plurality of work terminals 105 as in a case where a user performs inspection work while simultaneously viewing a plurality of drawings. In a case where the user operates a plurality of work terminals 105, work interruption associated with locking does not occur for terminals other than the terminal being operated, even if the data file is collected. Therefore, the data acquisition unit 1022 specifies the work terminal 105 being operated by the user, and collects data files only from the other work terminals 105.

In a case where the user uses a plurality of work terminals 105, for example, the user and each work terminal 105 are associated in the login authentication system, and the user may be configured to be able to log in only to the work terminal 105 with which the user himself/herself is associated (permitted to use). In this case, first, all the work terminals 105 associated with the user are specified on the login authentication system, and among the specified work terminals 105, the work terminal to which the user is logged in is being operated, and the other work terminals are not being operated. Using this procedure, the data acquisition unit 1022 is capable of specifying the work terminal 105 that is being operated/not being operated by the user.

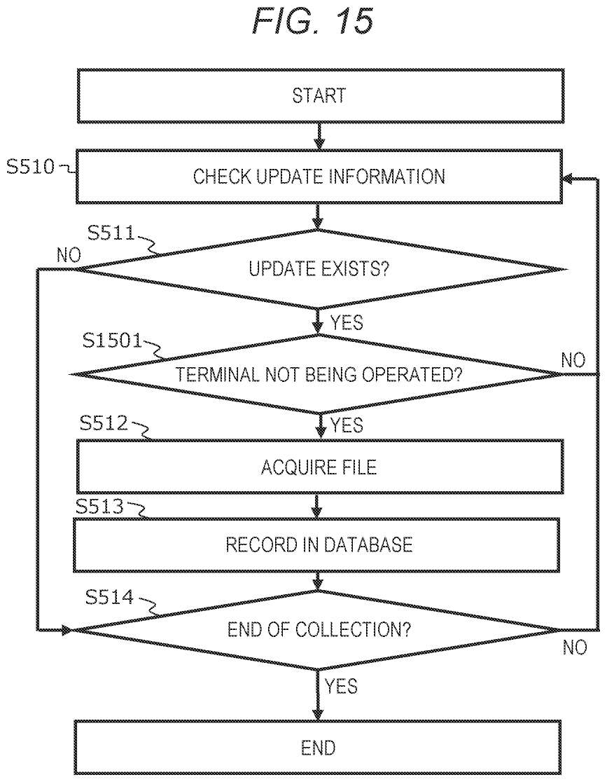

FIG. 15 is a flowchart illustrating a procedure when the data acquisition unit 1022 performs the operation of FIG. 13. The data acquisition unit 1022 performs S1501 between S51 and S512 illustrated in FIG. 5. In S1501, the data acquisition unit 1022 specifies the work terminal 105 that is associated with the user on the login authentication system and that is not being operated by the user. The data acquisition unit 1022 collects data files only from the work terminals 105 that are not being operated. Otherwise, the configuration is the same as that of FIG. 6.

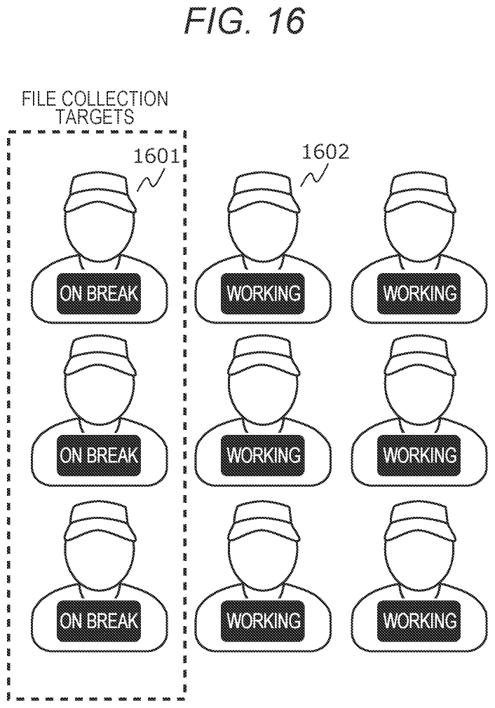

FIG. 16 is a schematic diagram illustrating a range of work terminals 105 collected by the server 102 according to the third embodiment. The work terminal 105 may be configured to enable setting of a status indicating that the user is on a break. For example, a break button is arranged on the operation screen of the work terminal 105, and while the button is pressed, a reply indicating that the user is on a break is sent when the state of the user is queried by the external terminal. In a case where the work terminal 105 is configured in this manner, the data acquisition unit 1022 may collect a data file only from the work terminal 105 used by the user 1601 who is on a break, and may not collect a data file from the work terminal 105 being used by the user 1602 who is working. As a result, it is possible to avoid a decrease in work efficiency due to the data file being locked.

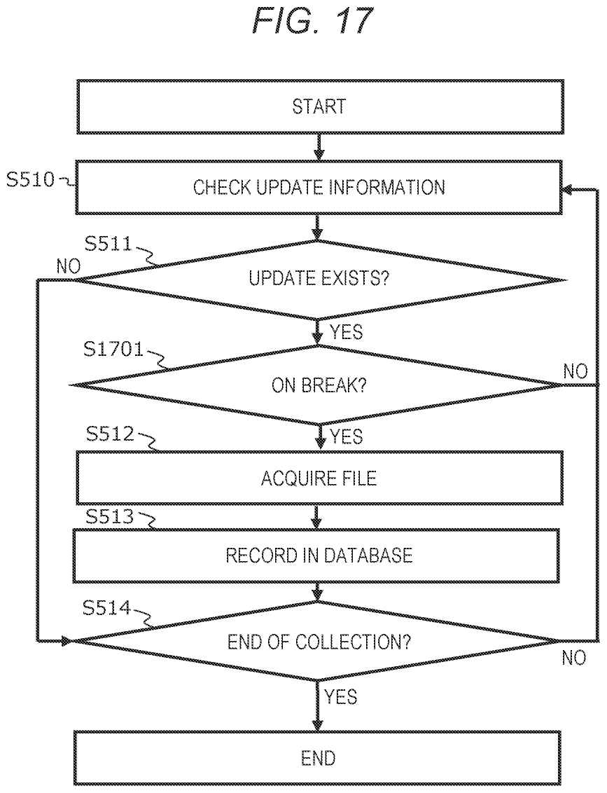

FIG. 17 is a flowchart illustrating a procedure when the data acquisition unit 1022 performs the operation of FIG. 16. The data acquisition unit 1022 performs S1701 between S511 and S512 illustrated in FIG. 5. In S1701, the data acquisition unit 1022 queries the work terminal 105 regarding whether the user is on a break. For example, a command querying whether or not the break button is pressed may be transmitted to the work terminal 105, and the work terminal 105 may reply thereto. The data acquisition unit 1022 acquires a data file only from the work terminal 105 during a break. Otherwise, the configuration is the same as that of FIG. 6.

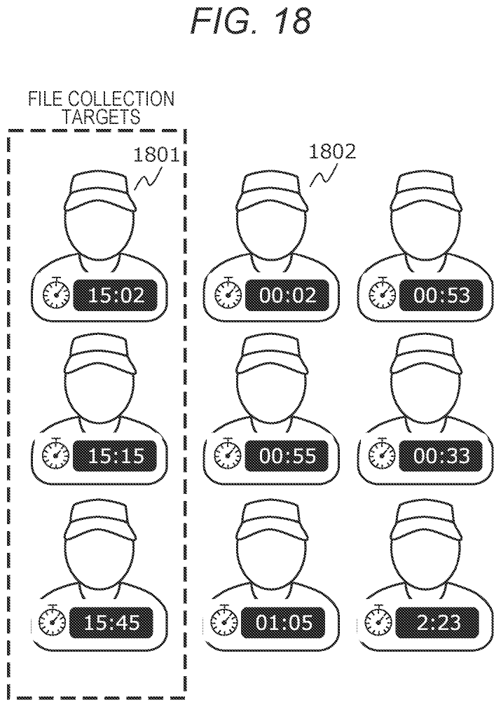

FIG. 18 is a schematic diagram illustrating a range of work terminals 105 collected by the server 102 according to the third embodiment. The data acquisition unit 1022 may collect a data file only from a work terminal 105 for which a predetermined time or more has elapsed since the data file was collected last time. In FIG. 18, a data file is collected only from a work terminal 105 (used by the user 1801) for which 15 minutes or more have passed since the data file was collected last time, and is not collected from a work terminal 105 (used by the user 1802) for which this time has not elapsed. As a result, it is possible to avoid a decrease in work efficiency due to the data file being locked. The two meanings described below can be considered for collecting a data file when a predetermined time has elapsed.

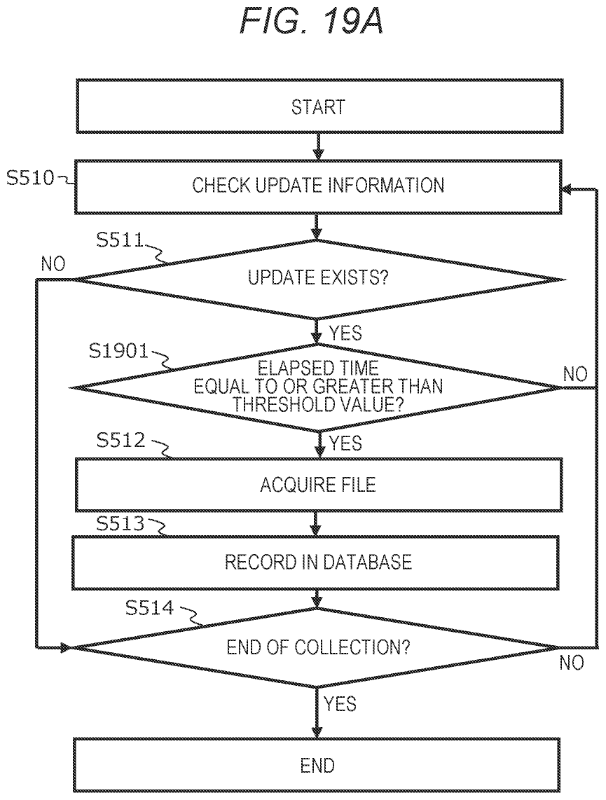

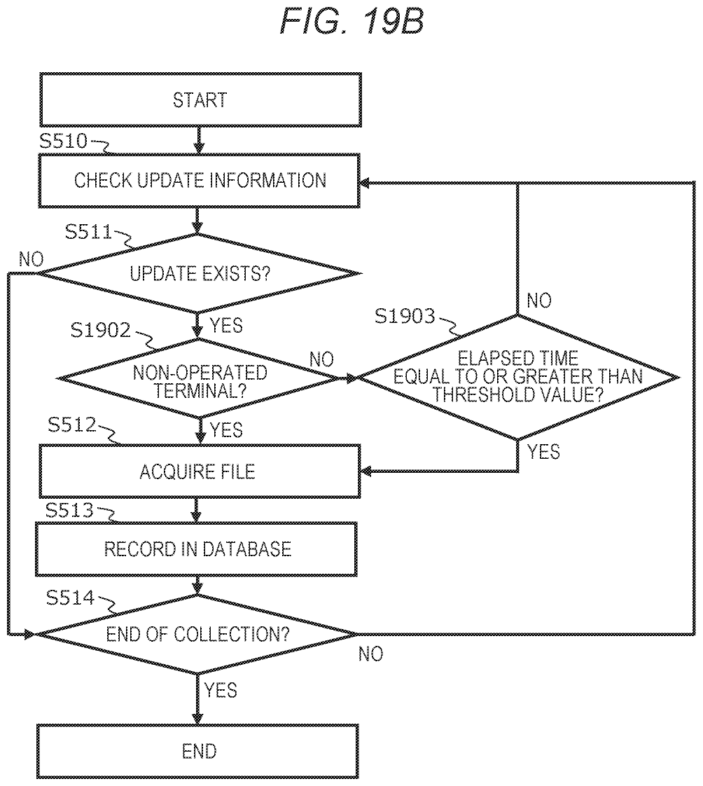

FIG. 19A is a flowchart illustrating a procedure when the data acquisition unit 1022 performs the operation of FIG. 18. The data acquisition unit 1022 performs S1901 between S511 and S512 illustrated in FIG. 5. In S1901, the data acquisition unit 1022 determines, for each work terminal 105, whether a predetermined time or more has elapsed since the data file was collected last time. In a case where the processing has elapsed, the processing from S512 is performed, and when the processing has not elapsed, the processing returns to S510. As a result, because the frequency of the data collection processing is suppressed, the processing load on the work terminal 105 and the server 102, respectively, can be suppressed.

FIG. 19B is a flowchart illustrating another procedure when the data acquisition unit 1022 performs the operation of FIG. 18. The data acquisition unit 1022 performs S1902 to S1903 between S511 and S512 illustrated in FIG. 5. In S1902, the data acquisition unit 1022 specifies a work terminal 105 that is not being operated by the user, similarly to S1501. For the work terminal 105 that is not being operated, data files are collected by S512 and subsequent steps. For the work terminal 105 being operated, it is further determined whether or not a predetermined time or more has elapsed since the data file was collected last time (S1903). If the predetermined time has not elapsed, the processing returns to S510. When the predetermined time has elapsed, the processing of S512 and subsequent steps is performed even for the work terminal 105 being operated. As a result, a state in which a data file cannot be collected due to the user continuously using the work terminal 105 for a long time can be prevented from continuing for a long time.

In S1902, as in S1301, a data file which is not being operated on by the user may be specified. For a data file that is not being operated on, the data file is collected using S512 and subsequent steps. For the data file which is being operated on, it is further determined whether or not a predetermined time or more has elapsed since the data file was collected last time (S1903). If the predetermined time has not elapsed, the processing returns to S510. When the predetermined time has elapsed, the processing of S512 and subsequent steps is executed even for the data file being operated on. As a result, a similar advantageous effect can be afforded in data file units.

### Third Embodiment: Summary

The work supporting apparatus (server 102) according to the third embodiment narrows down the work terminal 105 from which the data acquisition unit 1022 is to collect the data file, or the data file itself to be collected, to only the work terminal or the data file not being operated (on) by the user. As a result, it is possible to avoid a decrease in work efficiency due to locking associated with data file collection.

### Modifications of the Present Invention

The present invention is not limited to the above-described embodiments, and includes various modifications. For example, the above-described embodiments have been described in detail for easy understanding of the present invention, and are not necessarily limited to those having all the described configurations. Further, part of the configuration of one embodiment can be replaced with the configuration of another embodiment, and the configuration of another embodiment can be added to the configuration of one embodiment. In addition, it is possible to add, delete, or replace other configurations for part of the configuration of each embodiment.

In the above embodiments, it has been described that the monitoring unit 1021 acquires the page number currently displayed by the work terminal 105, and the data acquisition unit 1022 collects a specific page as part of the data file. Here, a case where a data file is configured in page units is described as an example, but these operations need not necessarily be performed in page units of the data file. That is, the monitoring unit 1021 only needs to be able to specify the portion of the data file currently displayed by the work terminal 105, and the data acquisition unit 1022 only needs to be capable of collecting an updated portion of the data file.

The methods described in the embodiments may be combined. For example, in the third embodiment, a plurality of methods have been described in which the data acquisition unit 1022 narrows down the work terminal 105 for which the data file is to be collected, but these methods may be combined as long as they do not contradict each other.

In the above embodiments, it has been described that the server 102 acquires the data file from a work terminal 105 only in a case where the update information (response to the query command) indicates that the data file has been updated on the work terminal 105. This means that the data file is acquired only at the time of a data update in order to perform subsequent updated content analysis processing, and it is additionally noted that acquisition of the data file for processing other than the updated content analysis processing is not hindered.

In the above embodiments, all or some of the monitoring unit 1021, the data acquisition unit 1022, the analysis unit 1023, and the display unit 1024 may be configured to be distributed across a plurality of servers 102. For example, a monitoring result by a monitoring unit 1021 which is disposed on a certain server may be stored in the database 106, and a data acquisition unit 1022 which is disposed on another server may acquire the monitoring result from the database 106 and collect the data file based on the acquired monitoring result.

In the above embodiment, the monitoring unit 1021, the data acquisition unit 1022, the analysis unit 1023, and the display unit 1024 can be configured from hardware such as a circuit device in which these functions are mounted, or can be configured as a result of an arithmetic unit such as a central processing unit (CPU) executing software in which these functions are mounted.

What is claimed is:

1. A work supporting apparatus that supports work performed by a worker using a work terminal, the work supporting apparatus comprising:
a monitoring unit that monitors an update state of a data file held by the work terminal; and
a data acquisition unit that acquires at least part of the data file from the work terminal, wherein
the monitoring unit acquires, from the work terminal, an update date and time of the data file and a position on the data file currently displayed by the work terminal,
the monitoring unit specifies an updated portion of the data file updated on the work terminal, based on the acquired update date and time and the acquired position, and
the data acquisition unit acquires the specified updated portion from the work terminal.

2. The work supporting apparatus according to claim 1, wherein
the monitoring unit periodically and repeatedly acquires the update date and time and the position from the work terminal,
the monitoring unit specifies the updated portion by acquiring the difference in the update date and time and the position between the repeatedly acquired instances of the update date and time and position, respectively, and
the monitoring unit accumulates a history of the specified updated portion.

3. The work supporting apparatus according to claim 1, further comprising an analysis unit that analyzes updated content of the data file, wherein
the data file has one or more pages,
the monitoring unit specifies the number of the updated page in the data file as the updated portion, and
the data acquisition unit acquires only the page corresponding to the updated portion in the data file.

4. The work supporting apparatus according to claim 3, wherein
the analysis unit analyzes the updated content of the data file by analyzing only the page acquired by the data acquisition unit, in the data file.

5. The work supporting apparatus according to claim 2, further comprising a storage unit that stores update history data in which a history of the updated portion is recorded, wherein
the monitoring unit overwrites the update date and time in the update history data each time the updated update date and time is acquired, and
every time the monitoring unit specifies a new updated portion, the monitoring unit adds information indicating the new updated portion, to the update history data.

6. The work supporting apparatus according to claim 1, wherein
the work terminal holds, as the data file,
input form data that holds a result obtained by the worker inputting a work record according to a predetermined input form and/or
handwritten record data configured from a combination of handwritten data, in which a path taken by a manual input on the work terminal by the worker is recorded, and write destination data in which the handwritten data is written,
in a case where the input form data is updated on the work terminal, the data acquisition unit acquires an updated portion of the input form data as the updated portion, and
in a case where the handwritten record data is updated on the work terminal, the data acquisition unit acquires only a newly updated portion of the handwritten data as the updated portion.

7. The work supporting apparatus according to claim 1, wherein
the monitoring unit specifies a work terminal among the plurality of work terminals which has received a login authentication from an authentication system that performs the login authentication on the worker, and
the monitoring unit monitors the update state of only the work terminal among the plurality of work terminals which has received the login authentication.

8. The work supporting apparatus according to claim 2, wherein
the work terminal is configured to return the data file currently displayed by the work terminal and a page number on the data file currently displayed by the work terminal in response to a query,
the monitoring unit determines whether or not the work terminal is in use by transmitting a command querying the position to the work terminal and acquiring a response to the command, and
the monitoring unit periodically and repeatedly acquires the update date and time and the position only from the work terminal being used.

9. The work supporting apparatus according to claim 1, wherein
the work terminal is configured to lock the data file which is in the middle of being acquired by the data acquisition unit such that the worker is at least unable to update the data file, and
the data acquisition unit acquires only the data file not being operated on by the worker on the work terminal.

10. The work supporting apparatus according to claim 1, wherein
the work terminal is configured from a first terminal and a second terminal,
the first terminal and the second terminal are defined as terminals used by the same worker in an authentication system that authenticates the worker, and
the data acquisition unit acquires the data file from a terminal among the first terminal and the second terminal for which the worker is in a state of not having received a login authentication on the authentication system, and does not acquire the data file from a terminal for which the worker is in a state of having received a login authentication.

11. The work supporting apparatus according to claim 1, wherein
the work terminal is configured to transmit information indicating whether the worker is working or taking a break, and
the data acquisition unit acquires the data file only from the work terminal that transmits a message to the effect that the worker is on a break.

12. The work supporting apparatus according to claim 1, wherein
the data acquisition unit determines whether or not a predetermined time or more has elapsed since the last acquisition of the data file from the work terminal, and
the data acquisition unit acquires the data file again only in a case where the predetermined time or more has elapsed.

13. The work supporting apparatus according to claim 1, wherein
the data acquisition unit determines whether or not a predetermined time or more has elapsed since the last acquisition of the data file from the work terminal,
the data acquisition unit acquires a data file that is not being operated on by the worker on the work terminal,
the data acquisition unit does not acquire the data file in a case where the worker is operating on the data file on the work terminal and the predetermined time has not elapsed, and
in a case where the worker is operating on the data file on the work terminal and the predetermined time has elapsed, the data acquisition unit acquires the data file regardless of whether or not the worker is operating on the data file.

14. The work supporting apparatus according to claim 1, further comprising an analysis unit that analyzes the data file, wherein
the monitoring unit, the data acquisition unit, and the analysis unit are arranged on the same apparatus.

15. A work supporting system, comprising:
the work supporting apparatus and
the work terminal according to claim 1, wherein
the work terminal is configured, upon receiving a command querying an update date and time of the data file and a position on the data file currently displayed by the work terminal, to respond to the query.
